(19) United States
(12) Patent Application Publication
(10) Pub. No.: US 2011/0155311 A1
(43) Pub. Date: Jun. 30, 2011

(54) LAMINATED PAPER FOR XEROGRAPHY TO REDUCE COST AND RECYCLING WASTE

(75) Inventors: Lee ACKERSON, Ben Lomond, CA (US); Eric J. SHRADER, Belmont, CA (US); Daniel L. LARNER, San Jose, CA (US)

(73) Assignee: Palo Alto Research Center Incorporated, Palo Alto, CA (US)

(21) Appl. No.: 12/647,687

(22) Filed: Dec. 28, 2009

(51) Int. Cl. B32B 38/10; B32B 9/00; B32B 29/00; B32B 27/00; H04Q 5/22

(52) U.S. Cl. 156/247; 428/411.1; 428/537.5; 340/10.1

(57) ABSTRACT

An imageable medium includes a reusable substrate and a removable surface layer semi-permanently bonded to a major surface of the substrate, the reusable substrate comprising an opaque backing to the removable surface layer and the removable surface layer comprising an imageable surface. A use indicator can be incorporated into the imageable medium, and correspond to at least one of the reusable substrate and removable surface layer. The use indicator can be an RFID chip. A method of imaging includes preparing an imageable medium by semi-permanently bonding an imageable layer to a reusable substrate, the reusable substrate providing an opaque backing to the imageable layer; imaging the imageable layer of the imageable medium; removing an imaged layer upon completion of use of the imaged medium; and repeatedly imaging a revealed imageable layer and removing the imaged layer.

### FIELD OF THE INVENTION

This invention relates generally to imaging and, more particularly, to a layered imageable medium, a portion of the layered medium being reusable and thereby reducing waste.

### BACKGROUND OF THE INVENTION

Paper documents are often promptly discarded after being read. Although paper is relatively inexpensive, the quantity of discarded paper documents is enormous and the disposal of these discarded paper documents raises significant cost and environmental issues.

Making, shipping, and disposing of paper can account for more than 80% of the energy consumed in the life cycle of an imaging device, such as a printer. If the quantity of paper pulp used per printed page can be reduced while still giving the user the full benefits of paper, a manufacturer can increase profit margins per ream of paper, reduce the volume of paper in the waste stream, and save considerable energy over the life of the printer.

It would, therefore, be desirable for at least a portion of an imageable medium, such as paper or the like, to be reusable, to thereby minimize both cost and environmental issues.

Thus, there is a need to provide an imageable medium, such as paper, in which at least a portion of the imageable medium is reusable, while still being cost effective and compatible for use in any variety of imaging devices.

### SUMMARY OF THE INVENTION

According to various embodiments, the present teachings include an imageable medium. The medium includes a reusable substrate; a removable surface layer semi-permanently bonded to a major surface of the substrate, the reusable substrate comprising an opaque backing to the removable surface layer and the removable surface layer comprising an imageable surface; and a use indicator incorporated into the imageable medium, and corresponding to at least one of the reusable substrate and removable surface layer.

According to various embodiments, the present teachings include a method of imaging. The method includes preparing an imageable medium by semi-permanently bonding an imageable layer to a reusable substrate, the reusable substrate providing an opaque backing to the imageable layer; imaging the imageable layer of the imageable medium; removing an imaged layer upon completion of use of the imaged medium; and repeatedly imaging a revealed imageable layer and removing the imaged layer.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1A is a perspective view of an imageable medium in accordance with the present teachings;

FIG. 1B is a side view of the imageable medium in accordance with the present teachings;

FIG. 1C is a side view of the imageable medium, with additional layers, in accordance with the present teachings;

FIG. 2 is a schematic view depicting exemplary processing of the imageable medium in connection with an imaging device, in accordance with the present teachings; and

FIG. 3 is an exemplary method of assembling, imaging, and reusing the imageable medium in accordance with the present teachings.

It should be noted that some details of the figures have been simplified and are drawn to facilitate understanding of the inventive embodiments rather than to maintain strict structural accuracy, detail, and scale.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

As used herein, the term “imaging” refers to any of conventional imaging such as ink jet, xerography, electrophotography, or the like, and any manual writing with pen, pencil, or similar implement, as known in the art. In the disclosure herein, imaging can further include an implement which can image the layered medium, without bleeding through an outermost imaged layer of the medium.

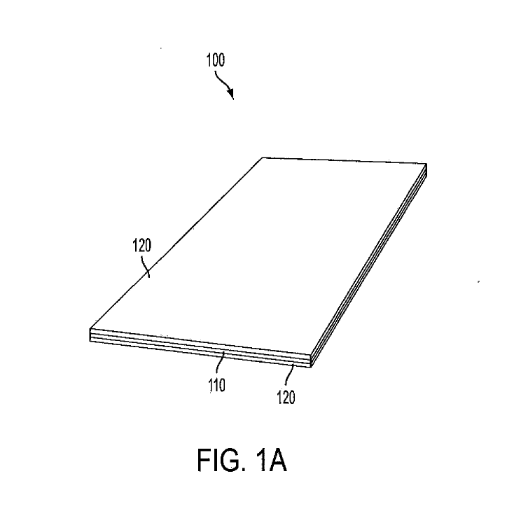

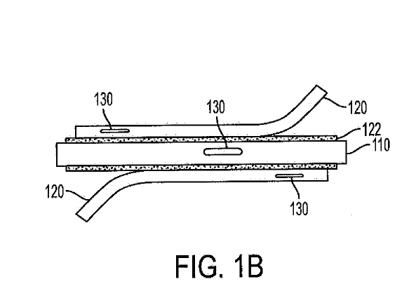

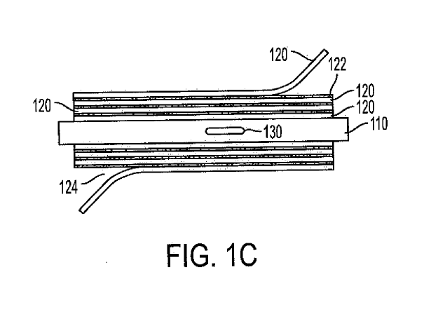

FIGS. 1A through 1C depict an exemplary imageable medium 100 in accordance with the present teachings. It should be readily apparent to one of ordinary skill in the art that the imageable medium 100 depicted in FIG. 1 represents a generalized schematic illustration and that other components can be added or existing components can be removed or modified. It will be appreciated that the imageable medium 100 and its components are not shown to scale, but are instead selectively enlarged to illustrate certain features for purposes of description.

As shown in FIGS. 1A through 1C, the imageable medium 100 can include a substrate 110 and a removable surface layer 120 formed on the substrate 110. As further described and shown in FIG. 1C, multiple removable surface layers 120 can be formed on the substrate 110. The removable surface layer 120 can define an imageable surface of the imageable medium 100.

The substrate 110 can include major surfaces 112 and 114 on opposing sides of the substrate. The substrate 110 can be of a material suitable for passage through and/or positioning on an imaging device, so as to be imaged in a known manner.

In various embodiments, the substrate 110 can be made of a flexible material and can be opaque or substantially opaque. The substrate 110 can be made of a substantially rigid material and can be opaque or substantially opaque. The substrate 110 can have a blank appearance and provide an opaque backing to the removable surface layer 120. The substrate 110 can be of a material and shape to provide a support for removable surface layers 120. The removable surface layers 120 can be a single layer or multiple layers on one or both of the major surfaces 112, 114. The substrate 110 can be a single layer or multi-layer where each layer is the same or different material and can have a thickness, for example, of about 5 mils.

The substrate 110 can include, for example paper, plastic, fabric, textile, polymeric films, inorganic substrates and/or similar material. In embodiments, the imageable medium 100, as a whole, can have the appearance and feel of traditional paper, including cardstock and other weights of paper. The substrate 110 can include, for example, plain papers such as XEROX® 4024 papers, ruled notebook paper, bond paper, and silica coated papers such as Sharp Company silica coated paper, Jujo paper, and the like. The substrate 110 can further include commercially available internally and externally (surface) sized papers include Diazo papers, offset papers such as Great Lakes offset, recycled papers, such as Conservatree, office papers, such as Automimeo, Eddy liquid toner paper and copy papers available from companies such as Nekoosa, Champion, Wiggins Teape, Kymmene, Modo, Domtar, Veitsiluoto, Sanyo, and coated base papers available from companies such as Scholler Technical Papers, Inc., opaque plastics, such as Teslin® available from PPG Industries, and filled polymers, such as Melinex®, available from ICI. Filled or unfilled plastics can be employed as the substrate, particularly when it is desired to make a more robust substrate that will stand up to the increased handling of multiple uses or to make a “never-tear paper” and the like.

The substrate 110 can further include an RFID chip 130. The RFID chip 130 can be embedded in the substrate 110, sandwiched between layers of the substrate 110, or can be otherwise formed with the substrate 110. The RFID chip 130 can be integrally formed with the substrate and can be of a one-piece construction with the substrate 110. The RFID chip 130 can include memory to identify and/or track printing and copying of the imageable medium 100. By tracking and/or identifying the imageable medium 100 with the RFID chip 130, an imageable medium 100 can, for example, be tagged to exclude copying of certain fields such as social security numbers, passport numbers, etc. In another application of the RFID chip 130, a number of uses of the imageable medium 100 can be determined.

The removable surface layer 120 can be on an outer surface 112,114 of the substrate 110. In various embodiments, the removable surface layer 120 can include multiple layers (see FIG. 1C), all sequentially positioned outward from the substrate 110. For example, about ten layers of the removable surface layer 120 can be configured on each major surface 112, 114 of the substrate 110. The removable surface layer 120 can cover all or part of the outer surface 112,114 of the substrate 110, according to an intended use of the imageable medium 100. A combination of the substrate 110 and multiple removable surface layers 120 on each major surface 112, 114 of the substrate 110 of the imageable medium 100, can have an overall thickness corresponding to that of conventional paper and as thick as known cardboards.

In various embodiments, the removable surface layer 120 can be made of a flexible material and can be transparent or opaque. While it is intended that the substrate 110 provide a support for removable surface layers 120, and that the overall imageable medium 100 have the look and feel of traditional paper, other options are intended to be included within the scope of this disclosure. For example the removable surface layer 120 can be of a substantially rigid material. The removable surface layer 120 can be a single layer or multi-layer where each layer is the same or different material and can have a thickness, for example, of less than about 50 microns. The removable surface layer 120 can further be of a thickness from about 10 to about 20 microns, for one layer or for one or more layers combined.

The removable surface layer 120 can include, for example paper, plastic, fabric, textile, polymeric films, inorganic substrates and/or similar material. In embodiments, the imageable medium 100, as a whole, can have the appearance and feel of traditional paper, including cardstock and other weights of paper. The removable surface layer 120 can include, for example, plain papers such as XEROX® 4024 papers, ruled notebook paper, bond paper, and silica coated papers such as Sharp Company silica coated paper, Jujo paper, and the like.

The substrate 110 can further include commercially available internally and externally (surface) sized papers include Diazo papers, offset papers such as Great Lakes offset, recycled papers, such as Conservatree, office papers, such as Automimeo, Eddy liquid toner paper and copy papers available from companies such as Nekoosa, Champion, Wiggins Teape, Kymmene, Modo, Domtar, Veitsiluoto, Sanyo, and coated base papers available from companies such as Scholler Technical Papers, Inc., opaque plastics, such as Teslin® available from PPG Industries, and filled polymers, such as Melinex®, available from ICI. Filled or unfilled plastics can be employed as the substrate, particularly when it is desired to make a more robust substrate that will stand up to the increased handling of multiple uses or to make a “never-tear paper” and the like.

The removable surface layer 120 can further include an RFID chip 130. The RFID chip 130 can be embedded in the removable surface layer, sandwiched between removable surface layers 120, or can be otherwise integrally formed with the removable surface layer 120. The RFID chip 130 can be included in each of multiple surface layers 120. The RFID chip 130 can include memory to identify and/or track printing and copying of the imageable medium 100, including removal of a removable layer 120 from an underlying removable layer 120 or substrate 110. By tracking and/or identifying the imageable medium 100 with the RFID chip 130, an imageable medium 100 can, for example, be tagged to exclude copying of certain fields such as social security numbers, passport numbers, etc. In another application of the RFID chip 130, a number of uses of the imageable medium 100 can be determined.

The removable surface layer 120 can removably adhere to the substrate 110 (or underlying removable surface layer 120) by a strong semi-permanent bond. The semi-permanent bond can include one of an adhesive 122 and an electrostatic attraction 124. In FIG. 1B, adhesive 122 is depicted on a first major surface 112 of the substrate 110 and the electrostatic attraction 124 is depicted on the second major surface 114 of the substrate 110. It will be appreciated that the depiction is for purposes of explaining both types of adhesion, and that one or both of adhesive 122 and electrostatic attraction 124 can be used to semi-permanently bond the removable surface layer 120 to either the substrate 110 or to an underlying removable surface layer 120. In either case, the strong semi-permanent bond is such that a removable surface layer 120 can be removed without damaging an underlying removable surface layer 120 or substrate 110.

Examples of suitable adhesive polymers for use as coating 100 for adhering backing substrates to imaged transparent substrates include Latex polymers (polymers capable of forming a latex is, for the purposes of the present invention, a polymer that forms in water or in an organic solvent a stable colloidal system in which the disperse phase is polymeric). In further examples, the adhesive can include a semi-permanent adhesive such as Easy-Tack by Krylon®, and Spray Mount Artists Adhesive by 3M®.

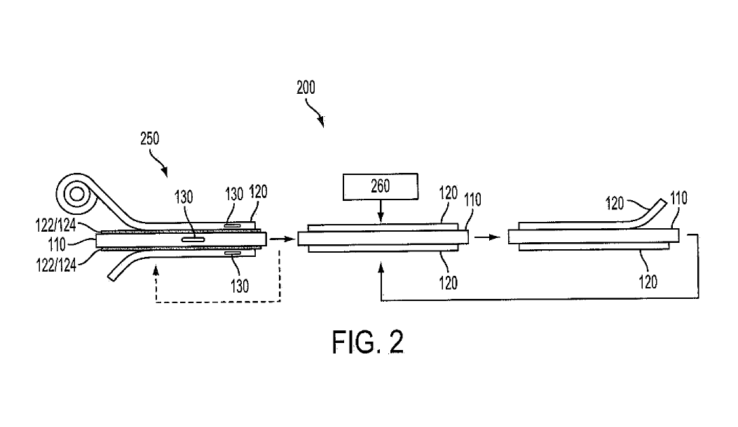

FIG. 2 is a schematic view depicting an exemplary handling system 200 for the imageable medium 100 in connection with an imaging device 250, in accordance with the present teachings. It should be readily apparent to one of ordinary skill in the art that the depiction in FIG. 2 represents a generalized schematic illustration and that other components can be added or existing components can be removed or modified.

As shown in FIG. 2, the handling system 200 can include an entire life cycle of the imageable medium 100. Various handling of the imageable medium 100 can include depositing of the removable layer 220 on a substrate 210 as generally depicted at 250; imaging of the imageable medium 100 by an imaging device 260; and removing the removable layer 220 as generally depicted at 270. It will be appreciated that the depicted handlings are not necessarily in order, and that other handling can occur besides that shown, for example embedding an RFID chip 230 in the substrate 110 or on or between one or more of the removable surface layers 120. Alternatively, the RFID chip 230 can be pre-disposed in the substrate 230 and/or one or more of the removable layers 220.

In general, the imageable medium 100 can be formed by applying one or more of the removable surface layer 220 to the substrate 210 or an underlying removable surface layer 220 as generally indicated at 250. The one or more removable surface layers 220 can include separate sheets which are separately applied and/or from a roll of removable surface layers which can be cut or perforated to a desired size the same as or different from the size of the substrate 210. A strong semi-permanent bond can be formed between the substrate 210 and removable surface layer 220, or between removable surface layers 220. The semi-permanent bond can include adhesive 222 and/or electrostatic attraction 224. As indicated, one or more and up to about ten removable surface layers 220 can be included on each major surface of the substrate 210. The imageable medium 100 can, therefore, be imaged as many as twenty times before exhausting the available removable surface layers 220. Upon exhaustion of the removable surface layers 220, the substrate 210 can be discarded. Alternatively, depending upon the integrity of the substrate 210, removable surface layers 220 can be added back to the substrate 210, thus forming a new imageable medium 100. The integrity of the substrate 210 can be determined visually. In addition, the integrity of the substrate 210 can be determined by the RFID chip 230 remaining in the substrate, for example by counting how many times the imageable medium 100 has been imaged, by counting how many removable surface layers 230 have been removed, etc.

In another handling aspect, imaging of the imageable medium 100 can occur. Imaging can be by a conventional imaging device and/or a manual writing implement as described above and generally indicated at 250. In embodiments, imaging can be xerographically, including ink jet, laser jet, etc. Imaging can render a permanent image on the imageable surface of a removable surface layer 220. The permanent image can be such that the image will be confined to a surface of the removable surface layer 220, i.e. without bleeding through to lower layers of the removable surface layers 220 or to the substrate 210. The imaged imageable medium 100 can be manipulated as is any conventional imaged paper or the like. Use can include, but is not limited to, distribution, stapling, folding, etc.

In another handling aspect, one or more removable surface layers 220 can be removed. Typically, removal of the removable surface layer 220 can be to expose a fresh (non-imaged) removable surface layer 220, which in turn can be imaged as described above. It will be appreciated, however, that a removable surface layer 220 can be removed to simply provide a cleaner surface for imaging, when for example, an exposed removable surface layer 220 has become dirty, torn, or otherwise becomes less than desirable. In embodiments, removal of the removable surface layer 220 can be manually and/or automatically, as would be appropriate to an overall system or end use. By way of example only, removal of the removable surface layer 220 can be by scraping, by heat to weaken a bond of the adhesive, by applying a peel force greater than the bond of the semi-bondable adhesive, and/or disturbing the electrostatic force holding immediately adjacent layers together.

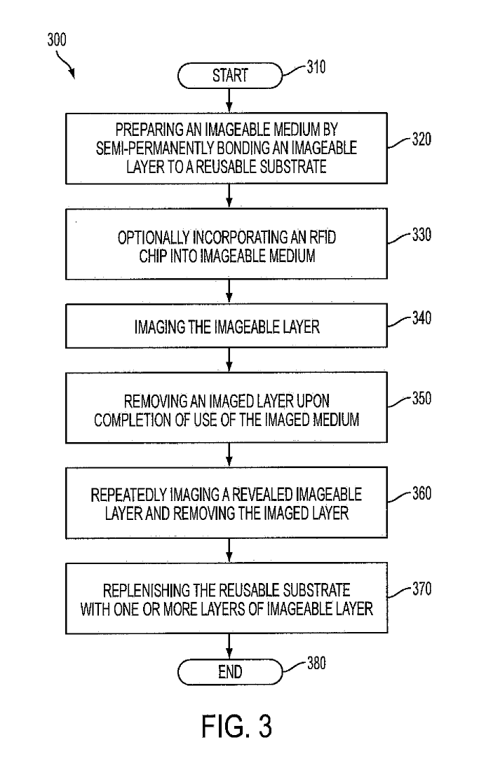

FIG. 3 depicts a method 300 in accordance with the present teachings. It should be readily apparent to one of ordinary skill in the art that the method 300 depicted in FIG. 3 represents a generalized schematic illustration and that other steps can be added or existing steps can be removed or modified.

The method 300 relates to a method of imaging, beginning at 310.

At 320, the method includes preparing an imageable medium by semi-permanently bonding an imageable layer to a reusable substrate, the reusable substrate providing an opaque backing to the imageable layer. Preparing can include semi-permanently bonding an imageable layer to opposing major surfaces of the substrate. In embodiments, preparing can include semi-permanently bonding plural layers of imageable layers to the reusable substrate. In certain embodiments, preparing can include semi-permanently bonding plural layers of imageable layers to the opposing major surfaces of the substrate.

At 330, the method can include optionally incorporating an RFID chip into the imageable medium for tracking usage thereof. The RFID can be incorporated into the reusable substrate, into one or more removable layers, or both.

At 340, the method includes imaging the imageable layer of the imageable medium. Imaging can be by conventional imaging devices, including but not limited to xerographic imaging. Imaging can further be by a conventional writing implement such as a pen, pencil, marker, etc.

At 350 the method includes removing an imaged layer upon completion of use of the imaged medium.

At 360, the method includes repeatedly imaging a revealed imageable layer and removing the imaged layer. The repeatedly imaging can include imaging until removing an imaged layer reveals the substrate. In certain embodiments, repeatedly imaging can include imaging until the substrate reaches a predetermined number of uses.

At 370, the method can include replenishing the reusable substrate with one or more layers of the imageable layer.

At 380, the method can end, but can return to certain points and repeat.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume values as defined earlier plus negative values, e.g. −1, −1.2, −1.89, −2, −2.5, −3, −10, −20, −30, etc.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An imageable medium comprising:
a reusable substrate; and
a removable surface layer semi-permanently bonded to a major surface of the substrate, the reusable substrate comprising an opaque backing to the removable surface layer and the removable surface layer comprising an imageable surface.

2. The medium of claim 1, further comprising a use indicator incorporated into the imageable medium, and corresponding to at least one of the reusable substrate and removable surface layer.

3. The medium of claim 2, wherein the use indicator comprises an RFID chip.

4. The medium of claim 3, wherein the RFID chip is embedded in the substrate.

5. The medium of claim 3, wherein the RFID chip is on a surface of the substrate.

6. The medium of claim 3, wherein the RFID chip identifies a document type.

7. The medium of claim 3, wherein the RFID chip tracks a number of uses of the reusable substrate.

8. The medium of claim 1, wherein an overall thickness of the reusable substrate and removable surface layer is suitable for use in an imaging device.

9. The medium of claim 1, further comprising a plurality of removable surface layers, on one or more major surfaces of the reusable substrate.

10. The medium of claim 1, wherein the reusable substrate comprises paper.

11. The medium of claim 1, wherein the substrate comprises plastic.

12. The medium of claim 1, wherein the substrate comprises a combination of plastic and paper.

13. The medium of claim 1, wherein the removable surface layer comprises paper.

14. The medium of claim 1, wherein the removable surface layer is semi-permanently bonded to opposing major surfaces of the reusable substrate.

15. The medium of claim 1, wherein the semi-permanent bond comprises an electrostatic attraction between immediately adjacent layers.

16. The medium of claim 1, wherein the semi-permanent bond comprises adhesive between immediately adjacent layers.

17. A method of imaging comprising:
preparing an imageable medium by semi-permanently bonding an imageable layer to a reusable substrate, the reusable substrate providing an opaque backing to the imageable layer;
imaging the imageable layer of the imageable medium;
removing an imaged layer upon completion of use of the imaged medium; and
repeatedly imaging a revealed imageable layer and removing the imaged layer.

18. The method of claim 17, wherein repeatedly imaging comprises imaging until removing an imaged layer reveals the substrate.

19. The method of claim 17, wherein repeatedly imaging comprises imaging until the substrate reaches a predetermined number of uses.

20. The method of claim 17, wherein preparing comprises semi-permanently bonding an imageable layer to opposing major surfaces of the substrate.

21. The method of claim 17, wherein preparing comprises semi-permanently bonding plural layers of imageable layers to the reusable substrate.

22. The method of claim 17, wherein preparing comprises semi-permanently bonding plural layers of imageable layers to the opposing major surfaces of the substrate.

23. The method of claim 17, further comprising incorporating an RFID chip into the imageable medium for tracking usage thereof.
